(19) United States
(12) Patent Application Publication
(10) Pub. No.: US 2014/0036870 A1
(43) Pub. Date: Feb. 6, 2014

(54) Method and Apparatus

(71) Applicants: Peter Skov, Beijing (CN); Xiao Yi Wang, Wheeling, IL (US); Chun Hai Yao, Beijing (CN)

(72) Inventors: Peter Skov, Beijing (CN); Xiao Yi Wang, Wheeling, IL (US); Chun Hai Yao, Beijing (CN)

(73) Assignee: Nokia Siemens Networks Oy, Espoo (FI)

(21) Appl. No.: 14/005,030

(22) PCT Filed: Mar. 16, 2011
(86) PCT No.: PCT/CN11/00422

§ 371 Date: Oct. 4, 2013

(51) Int. Cl. H04J 3/16

(52) U.S. Cl. CPC H04J 3/1694
USPC 370/331; 370/336

(57) ABSTRACT

A method includes receiving information at a first access node with which a user equipment is associated, said information including timing information of a second access node. The method also includes providing access node information for said user equipment in dependence on said timing information, said access node information defining at least one time period when said user equipment is to at least one of transmit to and receive signals from said at least one of said first and second access node.

The invention relates a method and apparatus and in particular but not exclusively to a method and apparatus for use in a system where a user equipment may associated with one access node and may be in range of another access node.

A communication system can be seen as a facility that enables communication sessions between two or more entities such as fixed or mobile communication devices, base stations, servers and/or other communication nodes. A communication system and compatible communicating entities typically operate in accordance with a given standard or specification which sets out what the various entities associated with the system are permitted to do and how that should be achieved. For example, the standards, specifications and related protocols can define the manner how communication devices can access the communication system and how various aspects of communication shall be implemented between communicating devices. A communication can be carried on wired or wireless carriers. In a wireless communication system at least a part of the communication between at least two stations occurs over a wireless link.

Examples of wireless systems include public land mobile networks (PLMN) such as cellular networks, satellite based communication systems and different wireless local networks, for example wireless local area networks (WLAN). A wireless system can be divided into cells, and hence these are often referred to as cellular systems. A cell is provided by a base station. Cells can have different shapes and sizes. A cell can also be divided into sectors. Regardless of the shape and size of the cell providing access for a user equipment, and whether the access is provided via a sector of a cell or a cell, such area can be called radio service area or access area. Neighbouring radio service areas typically overlap, and thus a communication in an area can listen to more than one base station.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station of an access network and/or another user equipment. The communication device may access a carrier provided by a station, for example a base station, and transmit and/or receive communications on the carrier.

An example of communication systems attempting to satisfy the increased demands for capacity is an architecture that is being standardized by the 3rd Generation Partnership Project (3GPP). This system is often referred to as the long-term evolution (LTE) of the Universal Mobile Telecommunications System (UMTS) radio-access technology. The LTE aims to achieve various improvements, for example reduced latency, higher user data rates, improved system capacity and coverage, reduced cost for the operator and so on. A further development of the LTE is often referred to as LTE-Advanced. The various development stages of the 3GPP LTE specifications are referred to as releases.

In LTE-Advanced the network nodes can be wide area network nodes such as a macro eNode B (eNB) which may, for example, provide coverage for an entire cell. Alternatively in LTE-Advanced, network nodes can be small area network nodes such as Home eNBs (HeNB) (femto cells) or pico eNodeBs (pico-eNB). HeNBs may be configured to support local offload and may support any UE or UEs belonging to a closed subscriber group (CSG) or an open subscriber group (OSG). Pico eNBs can, for example, be configured to extend the range of a cell. In some instances a combination of wide area network nodes and small area network nodes can be deployed using the same frequency carriers (e.g. co-channel deployment).

In coordinated multi-point (CoMP) technologies, dynamic cell selection is used. Multiple eNBs coordinate the setting of decisions based on the received channel state information. The serving eNodeB sends via the PDCCH (physical downlink control channel) information about the resource allocation to the UE. An eNodeB which may or may not be the serving eNodeB will then send the PDSCH (physical downlink shared channel) to the corresponding UE.

In the current CoMP proposals, dynamic cell selection only focuses on PDSCH coordination. However, in complex radio environments where there is a large amount of scattering or reflection, the user equipment may lose the PDCCH suddenly which may limit the dynamic cell selection.

Enhanced inter-cell interference coordination (E-ICIC) of for example LTE Rel 10, provides a time domain multiplexing (TDM) scheme to control macro cell to pico cell interference levels. For example, a user equipment in a pico cell is scheduled into macro cell almost blank sub-frames ABS. With ABS, only common reference symbols (CRS) and necessary control information (PSS (primary synchronisation channels), SSS (secondary synchronisation channels), PBCH (primary broadcast channel), and paging information) are transmitted. No other PDSCH will be transmitted with the current proposals. A bit map pattern is used to indicate the ABS pattern which is exchanged between the macro eNB and pico eNB through an X2 message.

Thus under the current E-ICIC schemes, the macro eNodeB schedules almost blank sub-frames according to a predefined pattern, the ABS pattern, to guarantee the pico cell edge user equipment performance. An ABS frame is generally a macro cell interference free sub-frame which can be used by the user equipment communicating with a pico eNB. However, this means that those pico cell-edge user equipment will only be scheduled in those ABS subframes. This limits the scheduling probability of pico cell-edge user equipment.

According to an aspect, there is provided a method comprising: receiving information at a first access node with which a user equipment is associated, said information comprising timing information of a second access node; and providing access node information for said user equipment in dependence on said timing information, said access node information defining at least one time period when said user equipment is to at least one of transmit to and receive signals from said at least one of said first and second access node.

According to another aspect, there is provided a method comprising: receiving at a user equipment access node information for said user equipment, said user equipment being associated with a first access node, said access node information defining at least one time period when said user equipment is to at least one of transmit to and receive signals from at least one of said first access node and a second access node; and using said access node information to control when said user equipment is to at least one of transmit to and receive signals from at least one of said first access node and the second access node.

A computer program comprising computer executable instructions which when run are configured to perform the method as described above.

According to another aspect, there is provided an apparatus for a first access node with which a user equipment is associated, said apparatus comprising at least one processor and at least one memory including computer program code, the at least one memory and computer program code configured to with the at least one processor cause the apparatus at least to: receive information comprising timing information of a second access node; and provide access node information for said user equipment in dependence on said timing information, said access node information defining at least one time period when said user equipment is to at least one of transmit to and receive signals from said at least one of said first and second access node.

According to another aspect, there is provided an apparatus for a user equipment, said apparatus comprising at least one processor and at least one memory including computer program code, the at least one memory and computer program code configured to with the at least one processor cause the apparatus at least to: receive access node information for said user equipment, said user equipment being associated with a first access node, said access node information defining at least one time period when said user equipment is to at least one of transmit to and receive signals from at least one of said first access node and a second access node; and use said access node information to control when said user equipment is to at least one of transmit to and receive signals from at least one of said first access node and the second access node.

Embodiments will now be described in further detail, by way of example only, with reference to the following examples and accompanying drawings, in which:

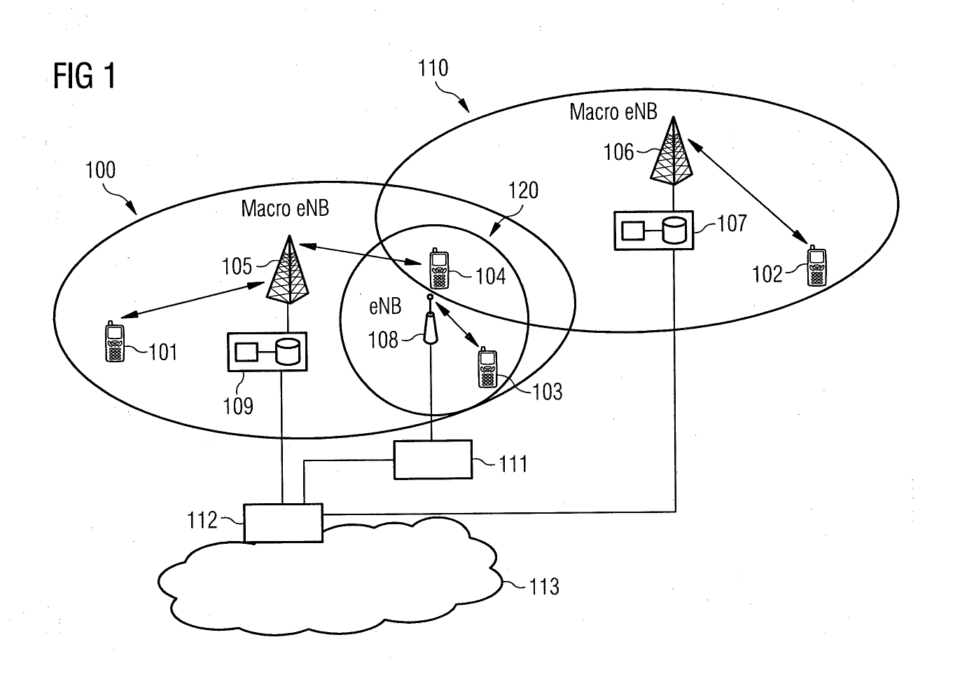

FIG. 1 shows a schematic diagram of a network according to some embodiments;

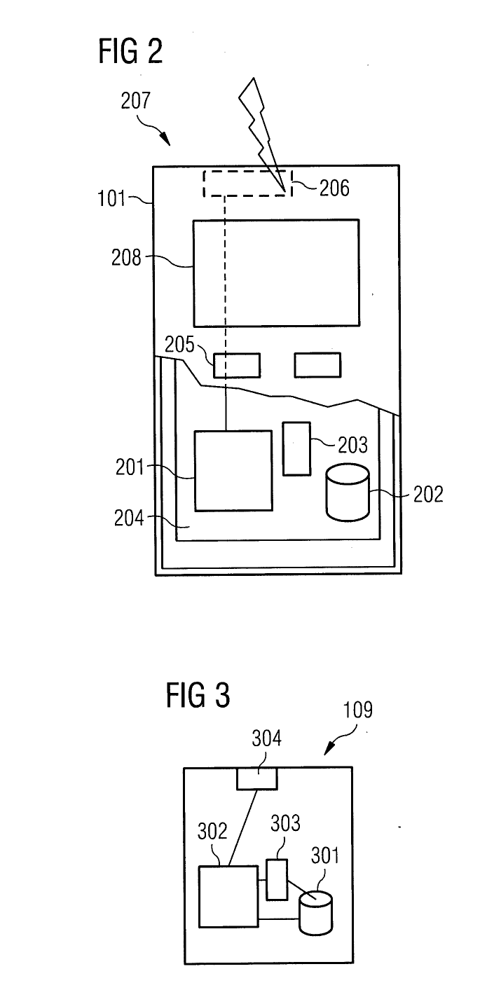

FIG. 2 shows a schematic diagram of a mobile communication device according to some embodiments;

FIG. 3 shows a schematic diagram of a control apparatus according to some embodiments;

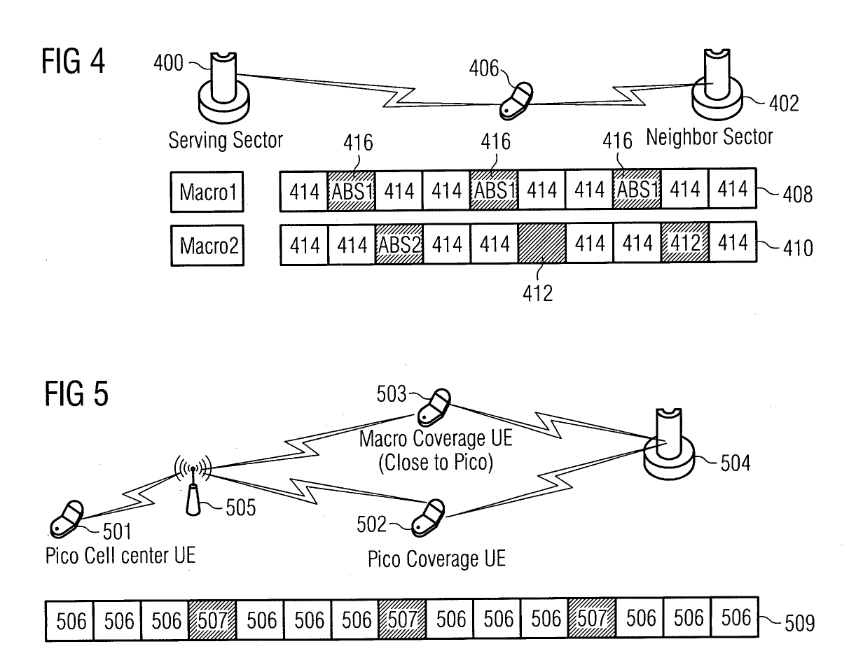

FIG. 4 shows schematic illustration of the ABS pattern of first and second macro cells;

FIG. 5 shows a schematic illustration of the ABS pattern in a macro/pico cell environment;

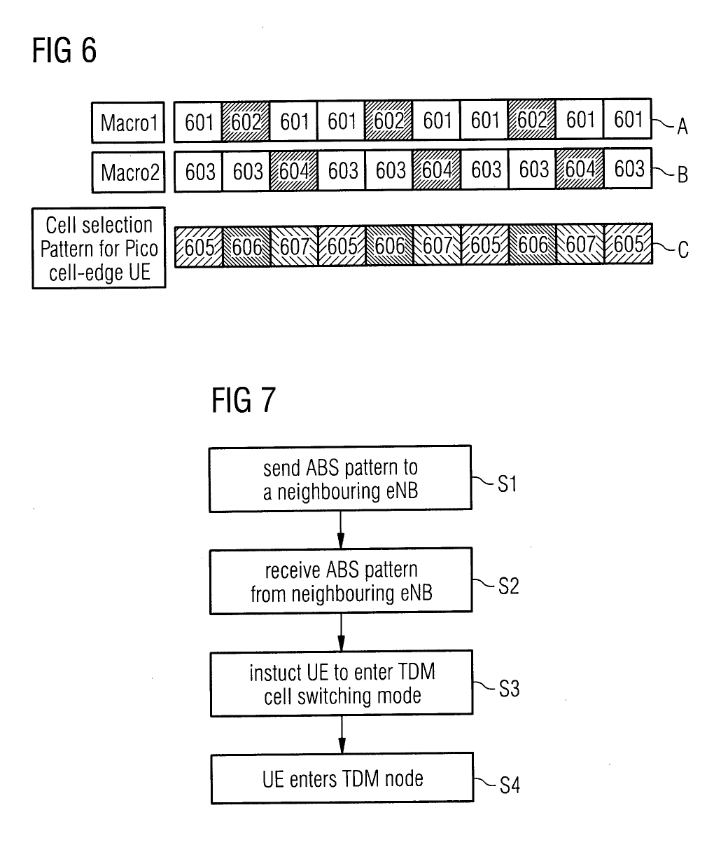

FIG. 6 shows a schematic illustration of a cell selection pattern for a pico cell edge UE; and

FIG. 7 shows a method of an embodiment.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A mobile communication device or user equipment 101, 102, 103, 104 is typically provided wireless access via at least one base station or similar wireless transmitter and/or receiver node of an access system. In FIG. 1 three neighbouring and overlapping access systems or radio service areas 100, 110 and 120 are shown being provided by base stations 105, 106, and 108.

However, it is noted that instead of three access systems, any number of access systems can be provided in a communication system. An access system can be provided by a cell of a cellular system or another system enabling a communication device to access a communication system. A base station site 105, 106, 108 can provide one or more cells. A base station can also provide a plurality of sectors, for example three radio sectors, each sector providing a cell or a subarea of a cell. All sectors within a cell can be served by the same base station. A radio link within a sector can be identified by a single logical identification belonging to that sector. Thus a base station can provide one or more radio service areas. Each mobile communication device 101, 102, 103, 104, and base station 105, 106, and 108 may have one or more radio channels open at the same time and may send signals to and/or receive signals from more than one source.

Base stations 105, 106, 108 are typically controlled by at least one appropriate controller apparatus 109, 107 so as to enable operation thereof and management of mobile communication devices 101, 102, 103, 104 in communication with the base stations 105, 106, 108. The control apparatus 107, 109 can be interconnected with other control entities. The control apparatus 109 can typically provided with memory capacity 301 and at least one data processor 302. The control apparatus 109 and functions may be distributed between a plurality of control units. Although not shown in FIG. 1 in some embodiments, each base station 105, 106 and 108 can comprise a control apparatus 109, 107.

The cell borders or edges are schematically shown for illustration purposes only in FIG. 1. It shall be understood that the sizes and shapes of the cells or other radio service areas may vary considerably from the similarly sized omnidirectional shapes of FIG. 1.

In particular, FIG. 1 depicts two wide area base stations 105, 106, which can be macro-eNBs 105, 106. The macro-eNBs 105, 106 transmit and receive data over the entire coverage of the cells 100 and 110 respectively. FIG. 1 also shows a smaller base station or access point which in some embodiments can be a pico eNB 108. The coverage of the smaller base station 108 may generally be smaller than the coverage of the wide area base stations 105, 106. The coverage provided by the smaller node 108 overlap with the coverage provided by the macro-eNBs 105, 106. In some embodiments, the smaller node can be a femto or Home eNB. Pico eNBs can be used to extend coverage of the macro-eNBs 105, 106 outside the original cell coverage 100, 110 of the macro-eNBs 105, 106. The pico eNB can also be used to provide cell coverage in “gaps” or “shadows” where there is no coverage within the existing cells 100, 110 and/or may serve “hot spots”.

As shown, the radio service areas can overlap. Thus signals transmitted in an area can interfere with communications in another area (macro to macro and pico to either one or both of the macro cells).

The communication devices 101, 102, 103, 104 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

Some non-limiting examples of the recent developments in communication systems are the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

In FIG. 1 the base stations 105, 106, 108 of the access systems can be connected to a wider communications network 113. A controller apparatus 107, 109 may be provided for coordinating the operation of the access systems. A gateway function 112 may also be provided to connect to another network via the network 113. The smaller base station 108 can also be connected to the other network by a separate gateway function 111. The base stations 105, 106, 108 can be connected to each other by a communication link for sending and receiving data. The communication link can be any suitable means for sending and receiving data between the base stations 105, 106 and 108 and in some embodiments the communication link is an X2 link.

The other network may be any appropriate network. A wider communication system may thus be provided by one or more interconnect networks and the elements thereof, and one or more gateways may be provided for interconnecting various networks.

The mobile communication devices will now be described in more detail in reference to FIG. 2. FIG. 2 shows a schematic, partially sectioned view of a communication device 101 that a user can use for communication. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

The mobile device 101 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus 109 for a communication system, for example to be coupled to and/or for controlling a station of an access system. In some embodiments the base stations 105, 106, and 108 comprise a separate control apparatus 109. In other embodiments the control apparatus can be another network element. The control apparatus 109 can be arranged to provide control of communications by mobile communication devices that are in the service area of the system. The control apparatus 109 can be configured to provide control functions in association with generation and communication of transmission patterns and other related information and for muting signals by means of the data processing facility in accordance with certain embodiments described below. For this purpose the control apparatus 109 comprises at least one memory 301, at least one data processing unit 302, 303 and an input/output interface 304. Via the interface the control apparatus can be coupled to a receiver and a transmitter of the base station. The control apparatus 109 can be configured to execute an appropriate software code to provide the control functions.

Some embodiments provide timing information relating to a cell different to the one to which the UE is attached. The timing information may take any form, such as cell switching information, cell switching pattern, a time domain pattern, reduced traffic time period information, an ABS sub frame information or any other suitable timing information. The UE will receive the different cell's signal in a time period indicated by the timing information. For example the UE will receive the different cell's signal in the sub-frame indicated by the ABS pattern.

It should be appreciated that this may alternative or additionally be used for controlling when a UE transmits to the different UE.

Some embodiments use a TDM type of cell switching scheme. A predefined pattern is known and using this predefined pattern, a user equipment will perform cell switching on both the PDCCH and PDSCH. Each user equipment may have a unique pattern and corresponding cells.

In the above embodiment, an ABS subframe is discussed. In other embodiments other types of subframe may be used. In some embodiment, this subframe may be one which has a reduced or almost no traffic such that a UE associated with a different access node is able to communicate with that different access node. In other embodiments, time periods other than subframes may be defined by the timing information.

Reference is made to FIG. 4 which shows a first CoMP scenario. Some embodiments can be used in macro-macro and/or macro-pico scenarios. In some embodiments there may be more gains in the macro-pico scenario, for example if the cell switching pattern is aligned with ABS pattern. Other embodiments can be used in a macro-femto, pico-femto, pico-pico, femto-pico scenario or any other combination. Of course, some embodiments may involve more than two cells.

As shown in FIG. 4, two eNodeBs are shown 400 and 402. This is a macro cell scenario and so the eNodeBs 400 and 402 are macro eNodeBs. Each macro eNodeB shall inform its neighbouring eNodeB of its ABS pattern. The line referenced 408 shows the ABS pattern for the first macro eNodeB 400. The pattern referenced 410 is the ABS pattern for the second macro eNodeB 402. The blocks 416 represent the ABS sub-frames for the first UE. As shown by line 408, the first base station 400 has a first normal sub-frame 414 followed by an ABS sub-frame 416. This is followed by two normal sub-frames 414. This is followed by a second ABS sub-frame 416 and so-on.

Reference is made to line 410 which shows the ABS sub-frame pattern for the second base station 402. In this case, the first two sub-frames are normal sub-frames 414. This is followed by an ABS sub-frame 412 for the second base station. This is followed by two normal sub-frames 414 and so-on. As can be seen, the ABS sub-frames of the first base station 400 occur at different times, i.e. different time slots to the ABS sub-frames of the second base station. The ABS sub-frame pattern of the first base station is provided to the second base station and vice versa.

The CoMP user equipment can decode the PDCCH/PDSCH of the first base station 400 in the normal sub-frame at the same time the cell associated with the second base station has an ABS sub-frame mode. Likewise, when the first base station has an ABS sub-frame mode, the user equipment can decode the PDCCH/PDSCH from the second base station 402.

An E-ICIC scenario will now be described with reference to FIG. 5. In some scenarios E-ICIC can be used for co-channel deployment of macro-eNBs and HeNBs and/or co-channel deployment of macro-eNBs and pico-eNBs.

Some user equipment, such as mobile communication devices 503 are located within the macro cell of eNB 504. The UE 503 receives and sends data to and from the macro-eNB 504. However this UE may be close to a pico cell coverage area or even in the pico cell coverage area.

User equipment 502 is associated with a pico eNodeB 505. The mobile user equipment 503 although in the macro coverage area may suffer interference from the pico eNodeB 505. User equipment 501 is located close to the centre of the pico cell associated with the pico eNodeB 505. According to the current TDM E-ICIC scheme, the almost blank sub-frame ABS is given by the macro eNodeB to guarantee the performance of the pico coverage user equipment. In embodiments, the pico coverage user equipment can try to decode the PDCCH/PDSCH from the macro eNodeB 504 during the normal sub-frames and decode the PDCCH/PDSCH from the pico eNodeB 505 during the ABS sub-frames of the macro eNodeB. The macro user equipment, for example UE 503 can also try to decode the PDCCH/PDSCH from the pico eNodeB 505 during the ABS sub-frames of the macro eNodeB as the macro eNodeB will not be sending any useful data during the ABS sub-frames.

Line 509 shows the sub-frame pattern of the macro base station 504. There are three normal sub-frames referenced 506 followed by an ABS sub-frame 507 and so-on.

It should be appreciated that the pico coverage user equipment 502 and 501 decodes the macro cell signals as this user equipment camps on the macro cell, in some embodiments, in line with the Release 8 cell selection criteria and selects the pico cell, for example for range extension purposes. In Rel.8, eICIC, coverage extension may be used to change the coverage area of a pico and/or macro cell. In some embodiments, the UE still access one eNB, either a macro or pico eNB. Additionally the UE is able to decode the signals from at least one other eNB.

Reference is now made to FIG. 7 which shows a flow diagram illustrating a method. In step S1, a macro eNodeB sends its ABS pattern to its neighbouring eNodeBs which may be a macro eNodeB, pico eNodeB, femto eNodeB, etc. This may be via the X2 connection or by any other suitable method.

In step S2, the macro eNB may receive ABS patterns from another eNB. This may be via the X2 connection or by any other suitable method. Steps S1 and S2 can take place at the same time or different times. Steps S1 and S2 can be in any order. Steps S1 and/or step S2 may periodically repeated. Some embodiments may omit step S1 or S2.

In step S3, in dependence on the UE reported RSRP (reference signal received power)/RSRQ (reference signal received quality) information, the pico or macro eNodeB may send RRC (radio resource control) signalling to ask that UE to enter the TDM cell switching mode. In some embodiments, normally only cell-edge (coverage overlapping area) UEs are requested to enter the TDM switching mode. In some embodiments, UE which are in a pico cell may be requested to enter the TDM cell switching mode. This request is provided by the controlling eNB usually but in some embodiments may be another of the eNBs. For example the another eNB may be a macro eNB. The controlling eNB may be the eNB on which the UE camps.

It should be noted that the RRC signalling may include all of their required system information which the user equipment requires in order to decode the PDCCH/PDSCH of the targeted cell and a TDM pattern. This TDM pattern may be the same as the ABS pattern if there is a single macro base station or more complex as described later. The TDM pattern is defined as the pattern that the user equipment should decode the neighbour cells PDCCH/PDSCH. This pattern may be defined by the controlling eNB or another eNB. In the TDM signalling, the cell-ID and/or any other suitable identification information of the other eNB is included.

The UE in step S4 receives the request and will enter the TDM mode. The eNodeB in the normal sub-frame can schedule a user equipment if the user equipment's serving cell is in an ABS sub-frame or if the serving cell is a pico cell controlled by that macro eNodeB. The UE will follow the TDM pattern and decode signals from the target cells with the cell ID included in the TDM signalling. The UE will thus be configured to receive signals from a different eNB to the one which normally serves the UE in for example an ABS subframe. Additionally or alternatively, the timing information may control when the UE transmits to the different eNB. In embodiments, the user equipment is controlled as to when the UE monitors one or more control channels from a particular eNB.

It should be appreciated that some embodiments are differentiated from traditional carrier aggregation where macro and pico cells are co-channel deployed because fast switching can only happen between different carriers transmitted from the same eNodeB. Some embodiments can use the carrier aggregation frame work and assume that the pico cell and serving cell are deployed on the same carrier but in different nodes—for example the pico cell in a macro cell or vice versa. Some embodiments do not require a UE to have or to use a dual component carrier capability, as may be required by carrier aggregation.

Some embodiments may have an advantage in that the PDCCH decoding efforts are reduced because the user equipment is informed that certain cells can be ignored in certain sub-frames.

In another example, when the user equipment power is on, according to the cell selection process, the user equipment will camp on a pico eNodeB. The pico eNodeB may command some cell-edge user equipment to enter a TDM cell selection mode and give a cell selection pattern to that user equipment. This pattern may be the same or different from the macro ABS pattern. For example, when the pico cell is in the middle of two macro eNodeBs, the pico eNodeB needs to consider the ABS pattern from two macro eNodeBs. FIG. 6 shows an example of a cell selection pattern.

Line A shows the ABS pattern from a first macro eNodeB. A first normal sub-frame 601 is followed by an ABS sub-frame 602 which is followed by two normal sub-frames 601. This inturn is followed by an ABS sub-frame 602 and so-on. The second eNodeB has an ABS pattern shown in line B. Two normal sub-frames 603 are followed by an ABS sub-frame 604 which is followed by two normal sub-frames 603 and so-on. It should be appreciated that the ABS sub frames of the first macro eNodeB occur at different times to the ABS sub-frame of the second macro eNodeB.

Line C shows the cell selection pattern for a pico cell-edge user equipment. In the first sub-frame 605, the pico cell-edge UE will decode the PDCCH/PDSCH from the either macro 1 or macro 2 eNodeB. In the next sub-frame 606, the UE will decode the PDCCH/PDSCH from the pico eNodeB. In the next sub-frame 607, the pico cell-edge UE will decode the PDCCH/PDSCH from the pico eNodeB. In some embodiments, where there are no pico nodes, a serving macro eNodeB can schedule a user equipment to enter the TDM cell switching mode and send the TDM pattern to the user equipment so the user equipment can decode the PDCCH/PDSCH in another cell whilst that serving cell is in the ABS mode. It should be appreciated that additional or alternative downlink channels may be decoded. Only one of the PDCCH and PDSCH may be decoded.

Reference has been made to subframes in the above embodiments. It should be appreciated that in other embodiments time slots, parts of time slots or any other suitable length of time may be used.

In the above embodiments, the ABS/normal subframes of an access node are shown has having a regular pattern. It should be appreciated that longer repeat times for a pattern can be provided or the ABS/normal subframes may be irregular arranged.

The ratio of ABS subframes to normal subframes may of course differ from the embodiments discussed above.

Some embodiments may be used for uplink and/or downlink communications.

Reference has been made to the PDDCH and PDSCH channels. It should be appreciated that other embodiments may use only one of these channels. Other embodiments may use one or more different channels.

It is noted that whilst embodiments have been described in relation to LTE-Advanced, similar principles can be applied to any other communication system. Also, instead of carriers provided by a base station a carrier comprising component carriers may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein. In some other embodiments the aforementioned embodiments can be adopted to other orthogonal frequency division multiple access (OFDMA) frequency division duplex (FDD) based mobile communication system other than LTE.

It is also noted herein that while the above describes exemplifying embodiments of the invention, there are several variations and modifications which may be made to the disclosed solution without departing from the scope of the present invention.

The required data processing apparatus and functions of a base station apparatus, a mobile communication device and any other appropriate station may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relewant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more of any of the other embodiments previously discussed.

1. A method comprising:
receiving information at a first access node with which a user equipment is associated, said information comprising timing information of a second access node; and
providing access node information for said user equipment in dependence on said timing information, said access node information defining at least one time period when said user equipment is to at least one of transmit to and receive signals from said at least one of said first and second access node.

2. (canceled)

3. A method as claimed in claim 1, wherein said access node information defines at least one time period when said user equipment is to monitor a control channel of said second access node.

4. A method as claimed in claim 1, wherein said timing information comprises a cell switching pattern.

5. A method as claimed in claim 1, wherein said timing information indicates a reduced traffic time period of said second access node.

6. A method as claimed in claim 1, wherein said timing information comprises almost blank sub frame information.

7. A method as claimed in claim 1, wherein said access node information is configured to control in which time periods said user equipment is configured to transmit to and/or receive signals from said first access node and in which time periods said user equipment is configured to transmit to and/or receive signals from said second access node.

8. A method as claimed in claim 1, comprising sending a request to said user equipment to cause said user equipment to enter a mode in which said user equipment is controlled by said access node information.

9. (canceled)

10. A method as claimed in claim 8 wherein said request comprises identity information identifying said second access node.

11. (canceled)

12. (canceled)

13. (canceled)

14. (canceled)

15. A method as claimed in claim 1, wherein said access node information determines when said user equipment decodes at least one channel and from which access node.

16. (canceled)

17. (canceled)

18. (canceled)

19. (canceled)

20. A method comprising:
receiving at a user equipment access node information for said user equipment, said user equipment being associated with a first access node, said access node information defining at least one time period when said user equipment is to at least one of transmit to and receive signals from at least one of said first access node and a second access node; and using said access node information to control when said user equipment is to at least one of transmit to and receive signals from at least one of said first access node and the second access node.

21. (canceled)

22. A method as claimed in claim 20, wherein said access node information defines at least one time period when said user equipment is to monitor a control channel of said second access node.

23. A method as claimed in claim 20, wherein said timing information comprises a cell switching pattern.

24. A method as claimed in claim 20, wherein said timing information indicates a reduced traffic time period of said second access node.

25. A method as claimed in claim 20, wherein said timing information comprises almost blank sub frame information.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. An apparatus for a first access node with which a user equipment is associated, said apparatus comprising at least one processor and at least one memory including computer program code, the at least one memory and computer program code configured to with the at least one processor cause the apparatus at least to:
receive information comprising timing information of a second access node; and
provide access node information for said user equipment in dependence on said timing information, said access node information defining at least one time period when said user equipment is to at least one of transmit to and receive signals from said at least one of said first and second access node.

41. Apparatus as claimed in claim 40, wherein the at least one memory and computer program code is configured to with the at least one processor to cause the apparatus to send a request to said user equipment to cause said user equipment to enter a mode in which said user equipment is controlled by said access node information.

42. (canceled)

43. (canceled)

44. (canceled)

45. Apparatus as claimed in claim 40, wherein the at least one memory and computer program code is configured to with the at least one processor to cause the apparatus to send said request to said user equipment responsive to re-ports received from said user equipment.

46. (canceled)

47. (canceled)

48. (canceled)

49. An apparatus for a user equipment, said apparatus comprising at least one processor and at least one memory including computer program code, the at least one memory and computer program code configured to with the at least one processor cause the apparatus at least to:
receive access node information for said user equipment, said user equipment being associated with a first access node, said access node information defining at least one time period when said user equipment is to at least one of transmit to and receive signals from at least one of said first access node and a second access node; and
use said access node information to control when said user equipment is to at least one of transmit to and receive signals from at least one of said first access node and the second access node.

50. Apparatus as claimed in claim 49, wherein the at least one memory and computer program code is configured to with the at least one processor to cause said user equipment to enter a mode in which said user equipment is controlled by said access node information in response to a request from the first access node.

51. (canceled)

52. (canceled)

53. (canceled)

54. (canceled)

55. (canceled)

56. (canceled)

57. (canceled)

58. (canceled)

59. Apparatus as claimed in claim 40, wherein said access node information defines at least one time period when said user equipment is to monitor a control channel of said second access node.

60. (canceled)

61. (canceled)

62. (canceled)

63. (canceled)

64. (canceled)

65. (canceled)

66. (canceled)

67. (canceled)

68. (canceled)

69. (canceled)
